(19) United States
(12) Patent Application Publication
(10) Pub. No.: US 2007/0296998 A1
(43) Pub. Date: Dec. 27, 2007

(54) Image processing apparatus

(75) Inventors: Tsuyoshi Iwamoto, Tenri-shi (JP); Shinichi Yamasaki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/812,739

(22) Filed: Jun. 21, 2007

(30) Foreign Application Priority Data
Jun. 23, 2006 (JP) 2006-173317

(51) Int. Cl. G06K 15/00

(52) U.S. Cl. 358/1.14

(57) ABSTRACT

Image processing apparatus, appropriate administration of the depletion load of the apparatus and confidential data can be facilitated without victimizing the convenience by combining use restriction of the job processing functions and causing another image processing apparatus as a substitute to execute the job processing without victimizing the convenience. The main controlling unit judges whether the use of each of the job processing functions in the apparatus that includes this main controlling unit is permitted or prohibited for a user (S303) and controls according to the judgment result. The main controlling unit further judges whether another image processing apparatus permits, as a substitute, the execution of the job processing of a portion of a setting job for which the execution is prohibited (S309) and causes another image processing apparatus that has judged to permit the execution of the processing as a substitute to execute the job processing.

### CROSS-NOTING PARAGRAPH

This Non-provisional application claims priority under 35 U.S.C. §119 (a) on Patent Application No. 2006-173317 filed in JAPAN on Jun. 23, 2006, the entire contents of which are hereby incorporated herein by reference.

### FIELD OF THE INVENTION

The present invention relates to an image processing apparatus including a communicating unit that communicates with external apparatuses.

### BACKGROUND OF THE INVENTION

Generally, an image processing apparatus such as a printer, a facsimile apparatus, a copying machine, or a multi-functional machine that has the functions of those apparatuses, includes a communicating unit (NIC: Network Interface Card) or a modem (Modulator-Demodulator) that communicates with external apparatuses (such as a computer and other image processing apparatuses) through a communication medium such as a network, a telephone line, and processes jobs received through the communicating unit (printing jobs, etc.) and jobs specified through a predetermined operation input unit such as a liquid crystal touch panel, etc., (copying jobs, etc.) using a scanner that realizes an image reading function or a printing engine (an exemplary job processing unit), etc., that realizes a printing function. Recent image processing apparatuses are more multi-functional with a data filing function and an email transmitting function in addition to the image reading function and the printing function.

On the other hand, Japanese Laid-Open Patent Publication No. 2001-067197 discloses a printer when an error has occurred during execution of a printing process based on a received printing job, that executes a substituting printing process which causes another printer to execute the remaining printing process by communicating with that another printer through a communication unit.

Japanese Laid-Open Patent Publication Nos. 2003-076521 and 2005-047264 disclose a system that transmits data processed (worked) by a printer to another printer connected to it through a network and causes that another printer to print the data instead of it. The above Japanese Laid-Open Patent Publication No. 2003-076521 also discloses that, when the substitute printing is restricted by the restriction on the use of the substitute printer, the substitute printing is executed by canceling the restriction.

The use restriction disclosed in the above Japanese Laid-Open Patent Publication No. 2003-076521 is executed in, for example, an image processing apparatus that includes a user-authenticating function and/or an energizing schedule-administrating function.

For example, some image processing apparatuses installed in each section of a company include a user authenticating function such that only the employees belonging to the section are permitted to use the apparatus and other persons are prohibited to use the apparatus, aiming to administrate the maintenance costs such as costs of supplies (developing solutions, recording paper sheets, etc.) section by section and to administrate the confidentiality of data stored (filed) in internal storing units such as a hard disk drive, etc.

Aiming at saving power consumption, some image processing apparatuses include an energizing schedule administering function that stops energizing to all the devices other than the minimum number of devices necessary for automatic start up when a predetermined time such as a night or a holiday (time during which devices are seldom used) comes, and automatically shifts the apparatus into a power-saving state (so-called a sleeping state) and, after the time has passed, starts energizing to all the devices again and the apparatus is automatically returned to the normal state.

An image processing apparatus such as a multi-functional machine includes a plurality of job processing functions such as an image reading function, a printing function, and an email transmitting function. However, the amount of consumption of the supplies, the degree of wear and tear of the apparatus, or the power consumption (hereinafter, collectively referred to as “depletion load”) differ depending on the job processing function(s) used. For example, in a copying job that uses the image reading function and the printing function, the depletion load in the use of the printing function is significantly heavier compared to that in the use of the image reading function. Therefore, the restriction of the use of the printing function is more important for appropriate administration of the depletion load compared to the restriction on the use of the image reading function.

Importance of the restriction on the use for the confidentiality administration differs depending on the job processing function(s) of the image processing apparatus. For example, the restrictions on the use of a function of printing data stored in an internal storing unit and of a function of taking out the data to an external storing medium (such as a USB memory) are important for confidentiality administration. However, no problem of confidentiality administration is arisen even when the use of the image reading function, etc., is permitted to an outsider.

However, in an image processing apparatus, a problem is arisen that convenience is more victimized as the scope of the use restriction is expanded for job processing functions (increase the time spans and functions for and on which the use is restricted) using the user authenticating function or the energizing schedule administrating function in order to enhance the appropriate administration of the depletion load or the confidentiality.

On the other hand, in an image processing apparatus, a problem has risen that the appropriate administration of the depletion load and the appropriate administration of confidential data are adversely influenced when, as described in, for example, the above Japanese Laid-Open Patent Publication No. 2003-076521, use restriction is alleviated by canceling the use restriction during the substitute printing in order to enhance the convenience.

### SUMMARY OF THE INVENTION

The object of the present invention is to provide an image processing apparatus which facilitates appropriate administration of the depletion load of the apparatus and confidential data (such as section by section administration and scheduling administration) without victimizing convenience as much as possible by combining use restriction (use prohibition) on job processing functions of the apparatus and substituting execution of job processing by another image processing apparatus.

The present invention is an image processing apparatus including a communicating unit that executes communication processing with external apparatuses (An NIC is a typical example.), and a job processing unit having a plurality of job processing functions (such as an image reading function and a printing function) to process jobs obtained through the communicating unit or jobs designated through a predetermined operation input unit, and also including the following (1) to (3) components.

(1) A function prohibition controlling unit that controls individually for each of a plurality of classifications whether the use of the job processing functions is permitted or prohibited.

(2) A substitute determining unit that judges whether other image processing apparatus permits, as a substitute, the substituting execution of job processing for a part or all of the jobs that use the job processing functions for which the use thereof is prohibited by the function prohibition controlling unit by communicating with external apparatuses through the communicating unit.

(3) A controlling unit of a job execution by a substitute that causes other image processing apparatus which is judged to permit, as a substitute, the execution of the job processing by the substitute determining unit to process a part or all of the jobs that need to use the job processing functions for which the use thereof is prohibited by the function prohibition controlling unit by transmitting the above part or all of the jobs through the communicating unit to the external apparatuses.

For example, the function prohibition controlling unit controls individually whether the use is permitted or prohibited for each of the image reading function and the printing function of the job processing functions that at least a copying job needs to use. In this case, when the use of the image reading function is permitted and the use of the printing function is prohibited by the function prohibition controlling unit, the controlling unit of a job execution by a substitute causes another image processing apparatus to execute, as a substitute, printing processing based on printing data obtained by using the image reading function of the apparatus for the copying job.

Because the image processing apparatus of the present invention can control individually for each of the plurality of classifications to prohibit or permit to use the plurality of job processing functions, the conditions for prohibition of a job processing function can be changed depending on the importance of the job processing function in executing the appropriate administration of depletion load of the apparatus and confidential data (such as section by section administration or scheduling administration). Even when a part of a job to be processed uses a job processing function of which use is prohibited, the part of the job can be executed by other image processing apparatus, as a substitute, that permits the job processing.

The controlling unit of a job execution by a substitute can be considered to be a unit that causes other image processing apparatus to directly execute as a substitute the job processing by transmitting the part or all of the job through the communicating unit to that other apparatus, or a unit that causes another image processing apparatus to indirectly execute as a substitute the job processing by transmitting the part or all of the job through the communicating unit to a predetermined relaying apparatus that can communicate with other image processing apparatuses.

An exemplary embodiment of the function prohibition controlling unit can be considered as a unit that controls whether the use of the job processing function(s) of the apparatus is permitted or prohibited based on the predetermined prohibiting conditions defined in advance, that is, the determination of the prohibiting conditions is executed by the unit of the apparatus.

In this case, the prohibiting conditions can be considered to be conditions that include one or both of user authentication condition based on identifying information of the requester of the job obtained through the communicating unit or a predetermined information input unit, and a condition based on a time schedule defined in advance.

On the other hand, another exemplary embodiment of the function prohibition controlling unit can be considered to be the function prohibition controlling unit itself controls whether the use of the job processing function(s) of the apparatus is permitted or prohibited based on the information obtained by the communication through the communicating unit with the external apparatuses. In this case, the function prohibition controlling unit executes the judgment of the prohibition conditions by an external apparatus or by the apparatus including the unit, and obtains the information necessary for the determination from the external apparatus.

In this case, the communication executed by the function prohibition controlling unit with the external apparatus may be considered to be the communication that includes one or both of the identifying information of the requester of the job obtained through the communicating unit or a predetermined information input unit and the identifying information of the image processing apparatus stored in advance in a predetermined storing unit.

The substitute determining unit judges whether another image processing apparatus permits or prohibits execution of the job processing by a substitute based on the information obtained by, for example, the communication with the external apparatuses through the communicating unit.

In this case, in addition to the case where a communication counterpart (an external apparatus) of the substitute determining unit is the other image processing apparatus that is a candidate that executes as a substitute the job processing, the case can be considered where a communication counterpart (an external apparatus) of the substitute determining unit is a predetermined relaying apparatus that can communicate with the other image processing apparatus as above.

A substitute determining unit can be considered, that includes a substitute determining unit setting unit that sets identifying information of another image processing apparatus that is subject to the determination by the substitute determining unit according to an operation input (an operation input by a user) through a predetermined operation input unit.

In this case, it can be considered that the substitute determining unit setting unit selects the identifying information according to the operation input through the predetermined operation input unit from candidates identifying information stored in advance in the predetermined storing unit or candidates identifying information obtained from external apparatuses through the communicating unit and, thereby, the identifying information of the other image processing apparatus that is subject to the determination by the substitute determining unit.

### BRIEF DESCRIPTION OF THE DRAWING

FIG. 1 depicts a block diagram of a schematic configuration of an image processing apparatus X and an image processing system Z including the apparatus X as a component thereof according to an embodiment of the present invention;

FIG. 2 depicts a block diagram of a schematic configuration of an NIC included in the image processing apparatus X;

FIG. 3 depicts a connection diagram of a power system in the image processing apparatus X;

FIG. 4 depicts a flowchart of a procedure for a weekly timer control in the image processing system Z;

FIG. 5 depicts a schematic diagram of a weekly schedule of the weekly timer control in the image processing system Z;

FIGS. 6A and 6B depict flowcharts of the procedure of a job substituting execution control in the image processing system Z; and

FIG. 7 depicts an example of data configuration of information referred to by an administrating server forming the image processing system Z.

### PREFERRED EMBODIMENTS OF THE INVENTION

Referring to the accompanying drawings, description will be given below for an embodiment of the present invention to support understanding of the present invention. However, the followings are the examples of the embodiments according to the present invention and are not intended to limit the technical scope of the present invention.

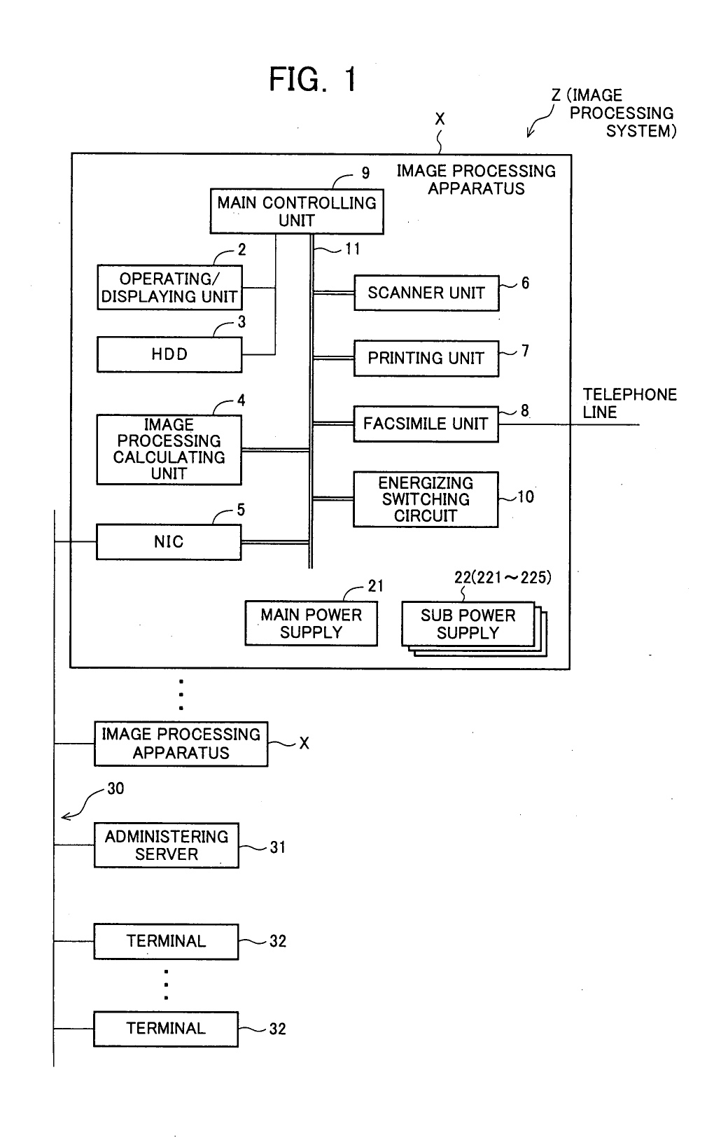

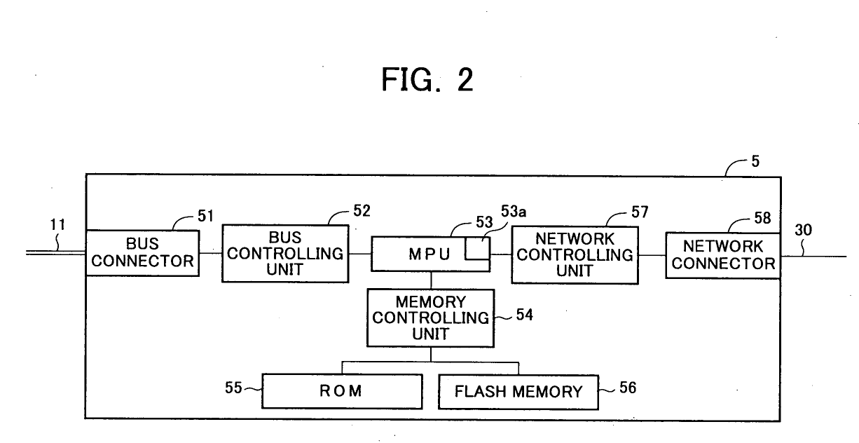

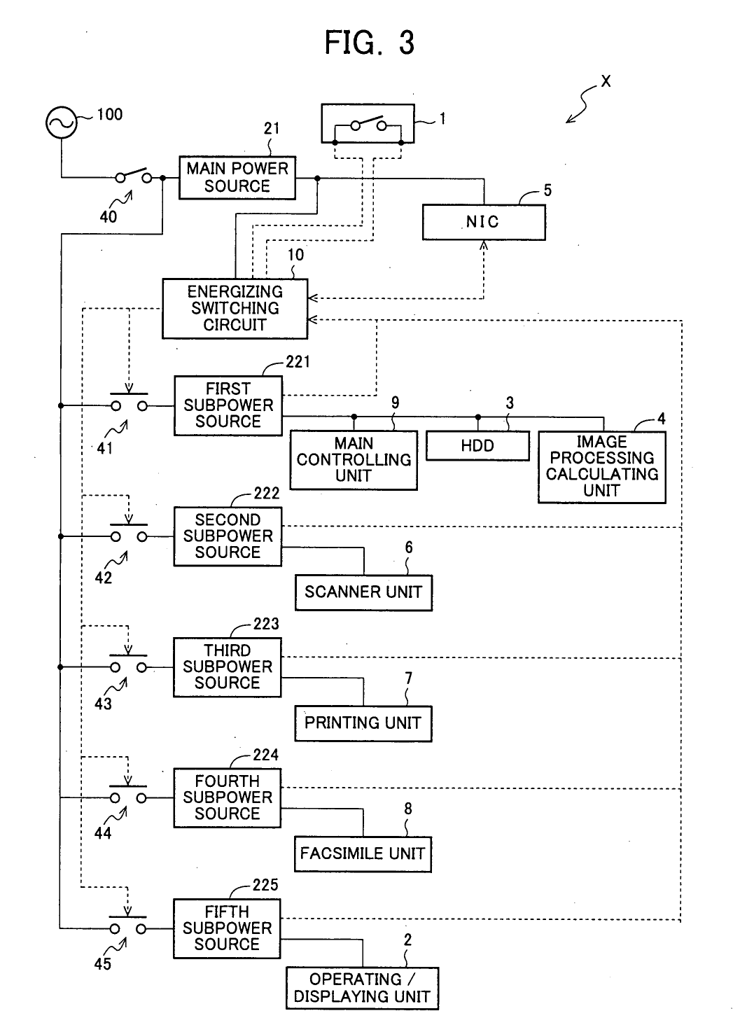

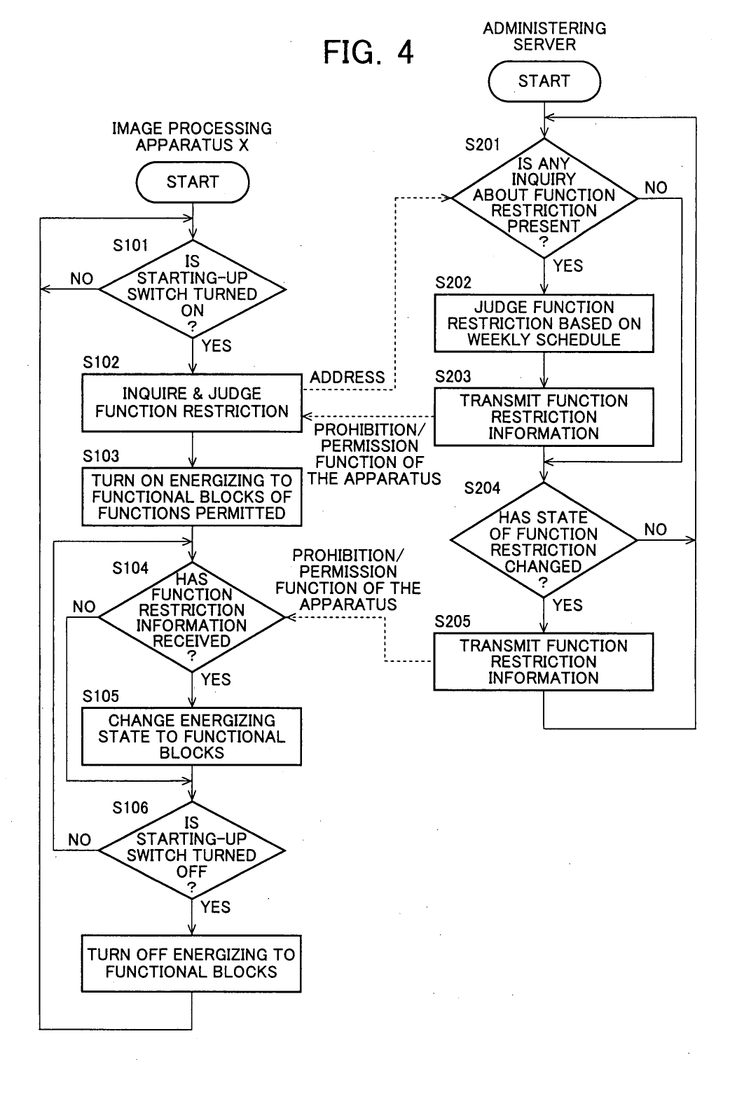

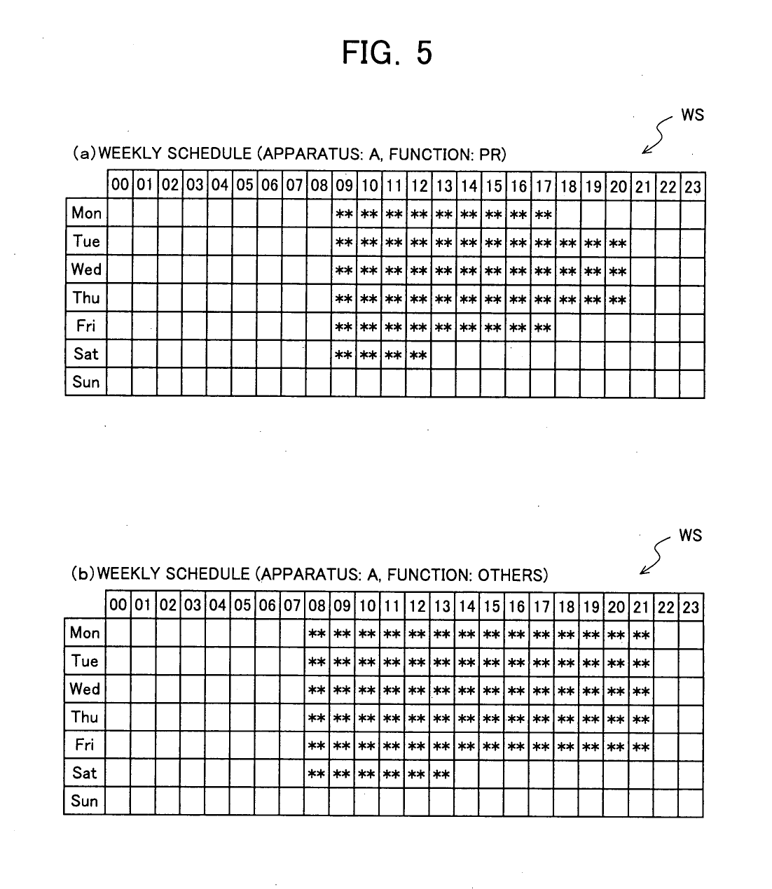

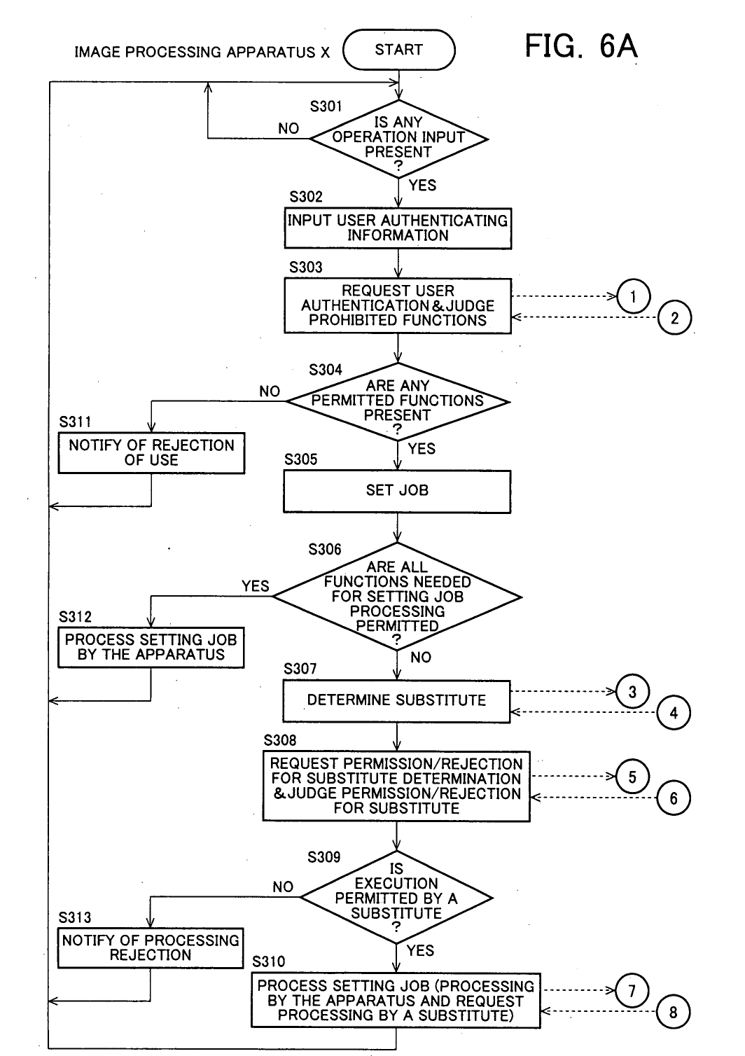

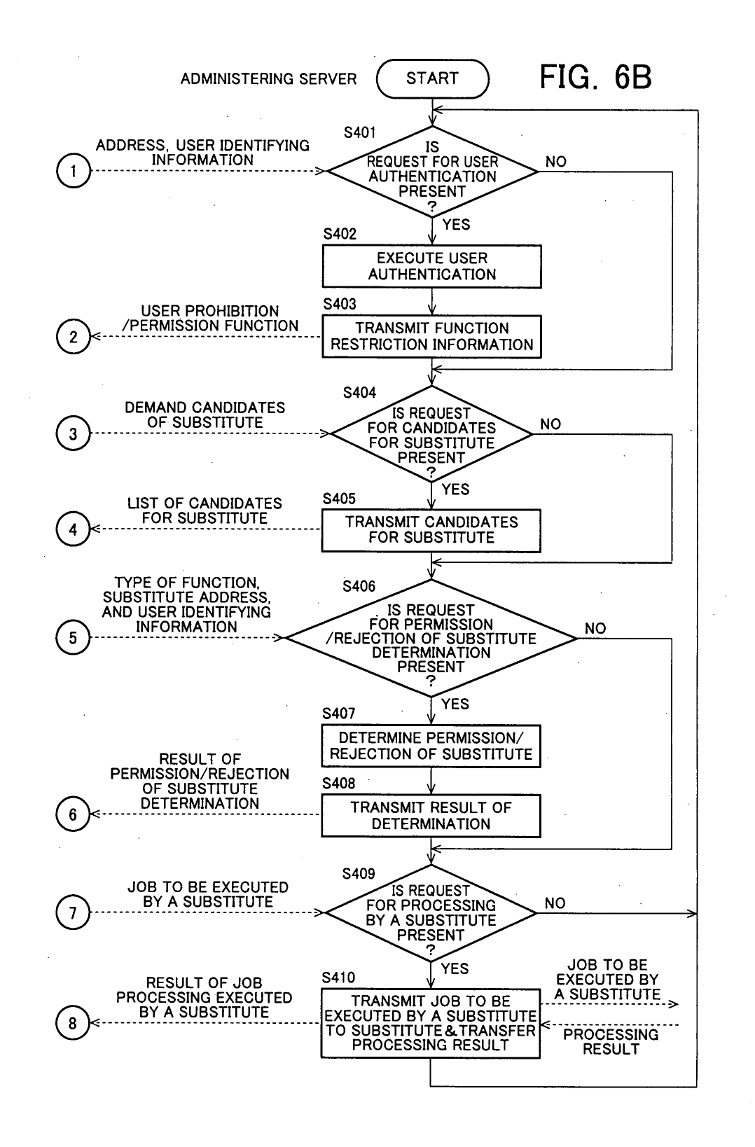

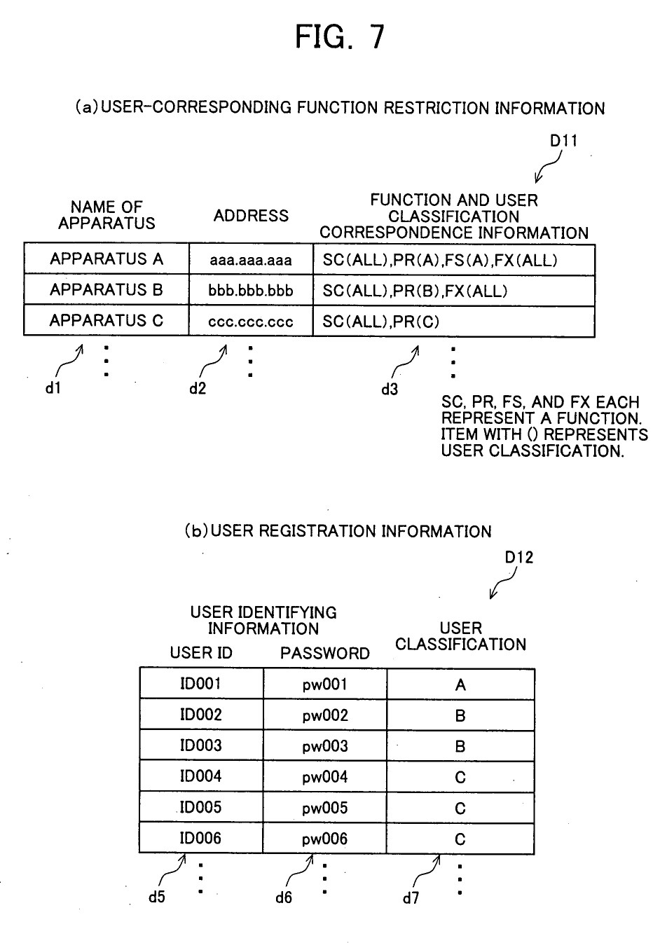

FIG. 1 depicts a block diagram of a schematic configuration of an image processing apparatus X and an image processing system Z including the apparatus X as a component thereof according to the embodiment of the present invention. FIG. 2 depicts a block diagram of a schematic configuration of an NIC included in the image processing apparatus X. FIG. 3 depicts a connection diagram of a power system in the image processing apparatus X. FIG. 4 depicts a flowchart of a procedure for a weekly timer control in the image processing system Z. FIG. 5 depicts a schematic diagram of a weekly schedule of the weekly timer control in the image processing system Z. FIGS. 6A and 6B depict flowcharts of the procedure of a job substituting execution control in the image processing system Z. FIG. 7 depicts an exemplary data configuration of the information referred to by an administrating server forming the image processing system Z.

Referring to the block diagram depicted in FIG. 1, description will be given for the image processing apparatus X and the image processing system Z including the apparatus X as a component thereof.

The image processing system Z is configured including the image processing apparatus X and an administrating server 31 that can communicate with the image processing apparatus X.

The image processing apparatus X includes a network interface card 5 (hereinafter, “NIC”) that executes communication with external apparatuses through a network 30 configured by LAN, WAN, etc. The image processing apparatus X communicates through the NIC 5 with a terminal 32 that transmits predetermined jobs such as a printing process to the image processing apparatus X and the administrating server 31, etc.

The terminal 32 is a computer such as a personal computer. The administering server 31 is a computer that includes a CPU, a storing unit such as a hard disk drive, the NIC that communicates through the network 30 with other apparatuses.

The image processing apparatus X includes a user administrating function that controls such that only predetermined users are permitted to use the apparatus X and others are prohibited to use the apparatus X by executing user authentication, and a weekly timer controlling function (an example of energizing schedule administering function) that controls the apparatus according to a predetermined weekly schedule so that the apparatus is automatically shifted into a sleeping mode in which energizing to devices other than the minimum number of devices is stopped and the use of the job processing functions is prohibited during a predetermined time span such as night time or a holiday (a time span during which the devices are seldom used), and the apparatus is automatically returned to an operating mode in which energizing to the devices is restarted and the use of all the job processing function is permitted after the time span has passed.

The user administrating function and the timer controlling function of the image processing apparatus X can control whether to permit or prohibit the use of the plurality of functions to process various jobs such as the copying job and the printing job (hereinafter, “job processing functions”) for each of a plurality of classifications individually.

The image processing apparatus X also includes a job substituting execution controlling function of causing a part of jobs given to it but it can not process by another image processor for it because the use of the job processing function(s) necessary for processing the job is prohibited by the user authenticating function or the weekly timer controlling function.

### [Image Processing Apparatus X]

The image processing apparatus X is formed to be able to communicate with external apparatuses (such as the terminal 32 and the administering server 31) through the network 30 including, for example, a LAN and a WAN, and includes the NIC 5 as an example of the communicating unit that executes the communication.

As depicted in FIG. 1, the image processing unit X includes an operating and displaying unit 2, a hard disk drive 3 (hereinafter, “HDD”), an image processing calculating unit 4, a scanner unit 6, a printing unit 7, a facsimile unit 8, a main controlling unit 9, an energizing switching circuit 10, a main power source 21, a sub power source 22, etc., in addition to the NIC 5.

In the example depicted in FIG. 1, the main controlling unit 9, the image processing calculating unit 4, the NIC 5, the scanner unit 6, the printing unit 7, the facsimile unit 8, and the energizing switching circuit 10 are connected to each other by a bus 11.

The NIC 5, the scanner unit 6, the printing unit 7, the facsimile unit 8, and the main controlling unit 9 are functional blocks which are composed of a part or an assembly of parts classified corresponding to the function. These functional blocks have a plurality of job processing functions to process jobs obtained through the NIC 5 and jobs designated through the operating and displaying unit 2 (an example of an operation input unit).

The jobs include, for example, a copying job, an image reading job (scanning job), a printing job, a facsimile transmission job, a file transmission job that is transmitting data files stored in the HDD 3 to the terminal 32, etc., in the LAN, an email transmission job that is transmitting email data stored in the HDD 3 to an email server (not shown).

The function that is used for executing the image reading job is the image reading function. The function that is used for executing the printing job is the printing function. The function that is used for executing the file transmission jog is the file transmitting function. The function that is used for executing the email transmission job is the email transmitting function. The copying job is executed by using both of the image reading function and the printing function for forming an image based on the image data obtained by the image reading function. The facsimile transmission job is executed by using the image reading function and the facsimile transmitting function for transmitting the image data obtained by the image reading function to a counterpart through a telephone line.

The image reading function is realized (executed) by the main controlling unit 9, the HDD 3, the image processing calculating unit 4, and the scanner unit 6. The printing function is realized by the main controlling unit 9, the HDD 3, the image processing calculating unit 4, and the printing unit 7. The email transmitting function is realized by the main controlling unit 9, the HDD 3, and the NIC 5. The facsimile transmitting function is realized by the facsimile unit 8.

The operating and displaying unit 2 includes an operation input unit to input information and a displaying unit to display information. The operation input unit is configured by, for example, a sheet key or a touch panel provided on the surface of a liquid crystal display. The displaying unit is configured by, for example, a liquid crystal display or LEDs. The operating and displaying unit constitutes a man-machine interface for a user.

The HDD 3 is a large-capacity non-volatile memory that stores the processing data at any time when processing the read image data that is read from an original copy or processing image data for printing, etc. The HDD 3 is also used as a storage site of email data obtained from an email server (not shown).

The image processing calculating unit 4 is configured by a signal processing circuit or a DSP (Digital Signal Processor), etc., designed for itself, executes various image processing on the image data, and executes the processing for converting a printing job described in a predetermined printing job describing language into a bit map image data used to form an image, the processing for producing image data (such as the image data to which, for example, a predetermined encoding method such as JPEG is applied) to be transmitted to the terminal 32, the processing for applying encrypting image data, the processing for decrypting the encrypted image data or the processing for compression encoding image data, the processing for expanding (restoring) the compression encoded image data, etc.

A configuration that a main controlling unit 9 provides a function of an image processing calculating unit 4 may be considered.

The scanner unit 6 is an assembly of a device that reads an image formed on an original copy from the original copy placed on a contact glass (not shown) or from the original copy conveyed by an ADF (not shown), and parts such as an MPU that controls the device.

In addition to the ADF, the scanner unit 6 includes, for example, a movable optical unit that is provided with a light source that applies a light beam to the image face of the original copy and a mirror that reflects a reflected light beam from the original copy toward a predetermined direction, and is configured to move along the original copy; a motor that drives the movable optical unit; a fixed mirror that leads the light beam emitted from the movable optical unit along a predetermined path; a lens that converges the emitted light beam; and a CCD (Charge Coupled Device) that photo-electrically converts the light beam that has passed through the lens and outputs an electric signal corresponding to the light amount of the light beam (that is, the reflected light beam on the image face of the original copy). The electric signal outputted from the CCD is transmitted to the image processing calculating unit 4 as image data.

The printing unit 7 is so-called a printing engine controlled by the main controlling unit 9 and is an assembly of a device that sequentially feeds recording paper sheets housed in a paper feeding cassette (not shown) one by one, and conveys the recording paper sheets through a predetermined image formation position to a paper discharging tray, a device that forms (outputs) an image on the recording paper sheet at the image formation position based on the image data of the original copy read from the original copy by the scanner unit 6 or the image data for printing produced by the image processing calculating unit 4, and parts such as an MPU that controls these devices.

The image processing apparatus X functions as a copying machine by executing a printing processing based on the image data of an original copy, and functions as a printer by executing a printing processing based on a printing request (printing job) received from the terminal 32.

The printing unit 7 includes, for example, a photo-sensitive drum that carries an image, a charging device that electrically charges the photo-sensitive drum, an exposure device that writes into the surface of the photo-sensitive drum a static latent image based on a given image data or a printing job, a developing device that develops the static latent image as a toner image, a transferring device that transfers the toner image on the photo-sensitive drum onto the recording paper sheet, a motor that drives the photo-sensitive drum and recording paper sheet conveying rollers, etc.

The facsimile unit 8 consisting of an NCU (Network Control Unit), and a modem, etc., executes dialing up and a negotiating processing for determining a communication method with a communication counter part (counter part station), and executes transmission/reception of facsimile data to/from another facsimile machine through a telephone line.

The NIC 5 is a communicating interface (an example of the communicating unit) that executes transmission/reception of data to/from the external apparatus such as the administering server 31 or an email server (not shown) through the network 30 including, for example, a LAN, the Internet, etc., that conform to the standard, “IEEE 802.3”, for example.

The main power source 21 and the sub power source 22 are power source circuits that supply electric power to each component of the image processing apparatus X.

The energizing switching circuit 10 is a switching circuit for individually energizing each of the functional blocks such as the main controlling unit 9, the scanner unit 6, the printing unit 7, and the facsimile unit 8 by controlling the connection of the sub power source 22 to a commercial power source according to a controlling signal received from the NIC 5. The energizing switching circuit 10 is configured to be able to switch on and off each of the main controlling unit 9, the scanner unit 6, the printing unit 7, and the facsimile unit 8 individually, and separately from the energizing to the NIC 5.

The main controlling unit 9 controls each of the scanner unit 6, the printing unit 7, the facsimile unit 8, the operating and displaying unit 2, the HDD 3, and the image processing calculating unit 4.

For example, main controlling unit 9 causes the printing unit 7 to execute a printing processing (image forming processing) based on a printing job received through the NIC 5. The main controlling unit 9 causes the facsimile unit 8 to execute a facsimile transmitting processing for making a call at a telephone number of a designated transmission destination and transmitting the image data to be transmitted. The main controlling unit 9 further causes the scanner unit 6 to execute a scanning processing for reading an image formed on an original copy from the original copy.

In addition, the main controlling unit 9 includes an email transmitting/receiving function which executes, through NIC 5, the processing for requesting and obtaining email data addressed to the apparatus that has this unit 9, stored in a storing unit of an email server (not shown) that can be communicated through the network 30 to the email server, and the processing for transmitting email data to which an email address of a transmission destination is set.

Referring to the block diagram show in FIG. 2, description will be given for the configuration of the NIC 5 that the image processing apparatus X includes.

The NIC 5 includes a bus connector 51, a bus controlling unit 52, an MPU 53, a memory controlling unit 54, a ROM 55, a flash memory 56, a network controlling unit 57, and a network connector 58, etc.

The bus connector 51 is a connector connected to the bus 11. The bus controlling unit 52 transmits signals from/to other devices through the bus 11.

The network connector 58 is a connector physically connected to the network 30. The network controlling unit 57 executes communication control that conforms to a predetermined network protocol such as, for example, the standards, “IEEE 802.3” or TCP/IP.

The MPU 53 is a calculating unit that executes various processing such as the processing for responding to the cases where the processing for relaying signal transmission between the bus 11 and the network 30 is requested or predetermined processing is requested from the terminal 32 through the network 30, by executing a program stored in advance in the ROM 55. The program is executed by being developed in a RAM (not shown) included in the MPU 53. The MPU 53 accesses to the ROM 55 and the flash memory 56 through the memory controlling unit 54.

The ROM 55 of the NIC 5 stores the program to be executed by the MPU 53 and the data referred to by the MPU 53.

On the other hand, the flash memory 56 of the NIC 5 stores the data stored and referred to when the MPU 53 executes the processing.

Referring to the power source system diagram depicted in FIG. 3, description will be given for an exemplary connection relation of a power source to the functional blocks in the image processing apparatus X.

In FIG. 3, solid lines represent power supplying lines and broken lines represent other signal transmitting lines.

In the example shown in FIG. 3, the image processing apparatus X includes five sub power sources 22 (221 to 225) that are hereinafter referred to as the first sub power source 221 to the fifth sub power source 225.

The main power source 21 is a power source that supplies electric power to the NIC 5 and the energizing switching circuit 10.

The main power source 21 is connected to a commercial power source 100 that is a basic electric power source to the entire image processing apparatus X, through a manual circuit changing switch 40 with which a power supplying line is manually conducted or not conducted. Energizing the NIC 5 and the energizing switching circuit 10 is switched by a user operating this manual circuit changing switch 40. Therefore, in the state where the image processing apparatus X is connected to the commercial power source 100, the NIC 5 and the energizing switching circuit 10 are normally energized unless the manual circuit changing switch 40 is switched from a conducting state to a non-conducting state by operation of the user. When the manual circuit changing switch 40 is switched to the non-conducting state, the entire image processing apparatus X is in a non-energized state (stopped state).

The first sub power source 221 is a power source circuit that supplies electric power to the main controlling unit 9, the HDD 3, and the image processing calculating unit 4.

The second sub power source 222, the third sub power source 223, the fourth sub power source 224, and the fifth sub power source 225 are power source circuits supply electric power respectively to the scanner unit 6, the printing unit 7, the facsimile unit 8, and the operating and displaying unit 2.

The first sub power source 221 to the fifth sub power source 225 are connected to the commercial power source 100 through the manual circuit changing switch 40 and automatic circuit changing switches 41 to 45 that switches the power supplying line to be conducted or not to be conducted according to a predetermined controlling signal. As being obvious from FIG. 3, the automatic circuit changing switch 41 and the first sub power source 221, the automatic circuit changing switch 42 and the second sub power source 222, the automatic circuit changing switch 43 and the third sub power source 223, the automatic circuit changing switch 44 and the fourth sub power source 224, and the automatic circuit changing switch 45 and the fifth sub power source 225 are respectively in corresponding relations.

Thereby, each of the sub power sources 221 to 225 can be energized when each of the automatic circuit changing switches 41 to 45 is energized after the automatic circuit changing switch 40 is energized.

Hereinafter, to conduct and not to conduct each of the power source supplying lines are respectively referred to as “to turn on” and “to turn off”. Similarly, the states where each of the power source supplying lines is conducted and cut off are respectively referred to as an “ON state” and an “OFF state”.

The automatic circuit changing switches 41 to 45 work as energizing switching apparatuses that switch functional blocks 2 and 6 to 9 on and off respectively with each of them coming into the ON state or the OFF state.

Hereinafter, in the image processing apparatus X, the state where the NIC 5 is in the energizing state (the state where the manual circuit changing switch 40 is conducting) and one or more of the functional blocks 2 and 6 to 9 are not energized (one or more of the automatic circuit changing switches 41 to 45 are in the OFF state) is referred to as a “sleeping mode”. The state where the NIC 5 and the functional blocks 2 and 6 to 9 are energized is referred to as an “operating mode”.

As depicted in FIG. 3, the NIC 5 individually controls the energizing to each of the functional blocks by controlling turning on and off of all of the automatic circuit changing switches 41 to 45 through the energizing switching circuit 10. That is, the NIC 5 also works as an apparatus that executes energizing control to the functional blocks (an example of the job executing unit).

The image processing apparatus X includes a starting-up switch 1 that switches the ON state and the OFF state thereof according to an operation of the user. The ON state and the OFF state of the starting-up switch 1 is detected by the MPU 53 of the NIC 5 through the energizing switching circuit 10.

The starting-up switch 1 works as an energizing switch that switches the image processing apparatus X into the operating mode or the sleeping mode.

When each functional block is energized, the mode of the image processing apparatus X is switched into the sleeping mode or into the operating mode by the weekly timer control based on a predetermined weekly schedule.

The sleeping mode is the state where the use of a part or all of the job processing functions are prohibited by cutting off the energizing to one or more functional blocks.

The operating mode is the state where the use of all of the job processing functions is permitted by energizing all of the functional blocks. However, even in the operating mode, the use of the job processing functions may be restricted by the above user administering function.

In the sleeping mode, one or more of the five automatic switches 41 to 45 are switched to the “OFF state” and the one or more functional blocks are in the “non-energized state”. In this case, when all of the five automatic switches 41 to 45 are switched to the “OFF state”, only a very few devices including the NIC 5 (the NIC 5 and the energizing switching circuit 10) are in the “energized state” in the image processing apparatus X.

In the embodiment, the administering sever 31 judges whether the use of each of the job processing functions is permitted or prohibited according to a weekly schedule described later, and transmits the judgment result (function restricting information described later) to the image processing apparatus X. The image processing apparatus X controls whether the use of each job processing function is permitted or prohibited by controlling the energizing state of each functional block based on the above judgment result obtained by communication with the administering server 31.

Referring to a flowchart depicted in FIG. 4, description will be given for a procedure of a weekly timer control in the image processing system Z. S101, S102, . . . , S201, S201, . . . , described below represent identifying symbols of the processing procedure (steps).

Description will be given below for the processing that the administering server 31 executes. The processing described below is realized by executing a predetermined program by the CPU of the administering server 31.

### [Steps S201 and S202]

Through the NIC that the administering server 31 itself includes, the administering server 31 executes at any time (for example, periodically) checking of whether an inquiry about restriction of a job processing function based on the weekly timer control (hereinafter, “inquiry about time restriction”) sent from the image processing apparatus X has been received (S201). This inquiry about time restriction includes a communication address of the image processing apparatus X as identifying information of the apparatus X that is the inquiry originator, in addition to a predetermined inquiry command.

When the administering server 31 detects the reception of the inquiry about time restriction, the server 31 judges the use restriction (whether the use is permitted or prohibited) of the job processing functions in the image processing apparatus X that has inquired about the time restriction based on a weekly schedule WS corresponding to the communication address included in the inquiry and the time of day at the time of the detection (the current time) (S202). In this case, the weekly schedule WS is the information stored in advance in a storing unit (such as a hard disk drive) included in the administering server 31.

The administering server 31 includes a certain clock circuit and the current time is counted by this circuit.

FIG. 5 schematically depicts the contents of the weekly schedule WS used in the weekly timer control. Each grid in (a) and (b) of FIG. 5 is a time span defined by day of the week (Monday to Sunday) and time of day (00:00 a. m. to 11:00 p. m.). A blank grid represents a time span for which setting of prohibiting the use of a job processing function (that is, setting of stopping energizing to the functional block corresponding to the job processing function) is made. A grid with “*” mark represents a time span for which setting of permitting the use of a job processing function (that is, setting of executing energizing to a functional block corresponding to the job processing function) is made.

The weekly schedule WS can be set individually for each of a plurality of classifications as to whether the use of each job processing function in each time span is permitted or prohibited, for the administering server 31 and each image processing apparatus X that can be communicated through the network 30. Each weekly schedule WS and each image processing apparatus X are correlated with each other by the communication address (identifying information) of the image processing apparatus X.

For example, for each image processing apparatus X, the weekly schedule WS can be set for each of the job processing functions (such as the image reading function, the printing function, and the facsimile function). For each image processing apparatus X, the weekly schedule WS can be set for a group including a plurality of job processing functions.

The weekly schedule WS depicted in (a) of FIG. 5 is an example of the schedules set for the printing function (function: PR) of an image processing apparatus X (apparatus: A).

The weekly schedule WS depicted in (b) of FIG. 5 is an example of the schedules set for a group of all of the job processing functions except the printing function (function: “others”) in the image processing apparatus X (apparatus: “A”).

In the weekly schedules exemplified in (a) and (b) of FIG. 5, the larger range (time span) of use prohibition is set for the printing function which has a heavy depletion load and the narrower ranges of use prohibition are set for the other job processing functions.

The administering server 31 has a function for setting the contents of the weekly schedule and storing them in the storing unit based on the information inputted from the operation input unit such as a keyboard included in the server 31 itself. The function is realized by the CPU of the administering server 31 executing a predetermined weekly schedule setting program.

Another type of administering server 31 is considered to have a function of updating the contents of the weekly schedules WS stored in the storing unit thereof in response to requests from the external terminal 32 through the network 30.

### [Steps S203 to S205]

The administering server 31 transmits (responds) the judgment result obtained at step S202 as the function restriction information to the transmission origin of the inquiry about the time restriction (the image processing apparatus X) (S203). Thereby, the image processing apparatus X obtains the restriction information of the job processing functions (information regarding whether the use of each of the job processing functions is permitted or prohibited) at the time when the communication for the inquiry about the time restriction was executed.

The administering server 31 checks at any time the sequentially-changing current time and the weekly schedules WS of all the image processing apparatuses X, and executes at any time (for example, periodically) the judgment of whether the state of restriction of the job processing functions in each of the image processing apparatuses X has varied (S204). In this case, “the state has been varied” refers to that the time span for a job processing function of each of the image processing apparatuses X is shifted from a time span during which the use is permitted to a time span during which the use is prohibited or vice versa.

When the administering server 31 detects that the state of the restriction of a job processing function has been varied, the administering server 31 transmits new function restriction information after the variation (information regarding whether the use of each of the job processing functions is permitted or prohibited) to the image processing apparatus X in which the variation has been detected through the NIC of the administering server itself (S205).

The administering server 31 repeats at any time the above processing steps (S201 to S205).

Description will be given for the processing that the image processing apparatus X executes in the weekly timer control.

### [Steps S101 and S102]

Th e MPU 53 of the NIC 5 in the image processing apparatus X monitors whether the starting-up switch 1 has been switched to the ON state (S101).

When the MPU 53 of the NIC 5 detects that the starting-up switch 1 has been switched to the ON state, the MPU 53 sends the inquiry about the time restriction (an inquiry about restriction of job processing functions based on the weekly timer control) through the network controlling unit 57 (the NIC 5) to the administering server 31, and judges whether the use of each of the plurality of job processing functions is permitted or prohibited (restriction of the job processing functions) based on a response to the inquiry (the function restriction information transmitted at step S203) (S102). In this case, the MPU 53 of the NIC 5 judges individually for each of the plurality of classifications whether the use of the job processing functions that the image processing apparatus X itself has is permitted or prohibited.

As described above, the inquiry about the time restriction includes the communication address (an example of the identifying information) of the image processing apparatus X stored in advance in the flash memory 56 of the NIC 5.

In the embodiment, it is assumed that the functional blocks which are to be power supplied from the first sub power source 221 and the fifth sub power source 225 (such as the main controlling unit 9 and the operating and displaying unit 2) are unconditionally energized by switching the starting-up switch 1 to the ON state.

### [Steps S103 and S104]

The MPU 53 of the NIC 5 controls the energizing switching circuit 10 such that only the functional blocks that realize the job processing functions the use of which is judged to be permitted at step S102 become the ON state (S103).

The MPU 53 of the NIC 5 checks at any time whether the function restriction information (the information to be transmitted in the process at step S205) has been received from the administering server 31 through the network controlling unit 57 (the NIC 5) (S104).

In this case, when the MPU 53 of the NIC 5 confirms that the function restriction information has been received (the latest restriction information of the job processing functions has been obtained), the MPU 53 judges whether the use of each of the plurality of job processing functions is permitted or prohibited (restriction of the job processing functions) based on the latest function restriction information, and changes the control state of the energizing switching circuit 10 (the state of energizing to each functional block) such that only the functional blocks that realize the job processing functions the use of which have been judged to be permitted become the ON state (S105).

When the MPU 53 of the NIC 5 judges that the function restriction information has not been received at step S104, the MPU 53 skips the processing at step S105.

### [Steps S106 and S107]

After it has been confirmed that the starting-up switch 1 is in the ON state by the processing at step S101, the MPU 53 of the NIC 5 again checks at any time whether the starting-up switch 1 is shifted to the OFF state (S106).

While the starting-up switch 1 is in the ON state, the MPU 53 of the NIC 5 repeats the processing of steps S104 to S105.

When the MPU 53 of the NIC 5 confirms that the starting-up switch 1 has been shifted to the OFF state at step S106, the MPU 53 returns the process to step S101.

After this, (the MPU 53 of) the NIC 5 and the main controlling unit 9 of the image processing apparatus X permits the use of only the job processing functions that can be executed by the functional blocks being energized, and prohibits the use of the job processing functions realized by the functional blocks for which energizing is stopped.

Due to the above processing, (the MPU 53 of) the NIC 5 and the main controlling unit 9 of the image processing apparatus X control individually for each of the plurality of classifications whether the use of each of the job processing functions is permitted or prohibited by switching whether energizing is executed to a functional block corresponding to each of the job processing functions (one or more of the scanner unit 6, the printing unit, and the facsimile unit 8) of the job processing functions that the image processing apparatus X itself has according to the result of the judgment of whether the use is permitted or prohibited in the processing at step S102 or S105 (an example of the function prohibition controlling unit).

Especially, by setting the weekly schedules WS as depicted in (a) and (b) of FIG. 5, (the MPU 53 of) the NIC 5 and the main controlling unit 9 of the image processing apparatus X control whether the use is permitted or prohibited separately for the image reading function and the printing function of the job processing functions that the copying job needs to use.

Referring to the flowcharts depicted in FIGS. 6A and 6B, description will be given for the procedure of job substituting execution control in the image processing system Z. S301, S302, . . . , S401, S401, . . . , described below represent identifying symbols of the processing procedure (steps).

Description will be given below for the processing that the administering server 31 executes. The processing described below is realized by the CPU of the administering server 31 executing a predetermined program.

### [Steps S401 to S403]

As depicted in FIG. 6B, the administering server 31 checks at any time (for example, periodically) whether predetermined information of a user authentication request sent from the image processing apparatus X through the NIC included in the image processing apparatus X itself has been received (S401). The information of the user authentication request includes a communication address of the image processing apparatus X that is the request origin (identifying information) and identifying information of the user who has transmitted or inputted a job to the image processing apparatus X (the user ID and a password), in addition to a predetermined request command.

When the administering server 31 detects that the administering server 31 has received the information of the user authentication request, the administering server 31 executes a user authenticating processing based on the combination of the communication address (identifying information) of the image processing apparatus and the user identifying information included in the request information (S402).

The user authenticating process is the processing of checking whether the user who requested the authentication is permitted or prohibited to use each of the job processing functions.

The administering server 31 transmits (responds) the function restriction information that is the authentication result (judgment result) at step S402 to the image processing apparatus X that is the request origin (S403).

Description will be given below for the user authenticating processing at step S402.

FIG. 7 depicts an example of data configurations respectively of user-corresponding function restriction information D11 and user registration information D12 which are referred to by (a CPU of) the administrating server 31. Both information D11 and D12 are stored in advance, for example, in the storing unit (such as a hard disk drive) of the administering server 31.

As depicted in (a) of FIG. 7, the user-corresponding function restriction information D11 is the information that includes an apparatus name d1, a communication address d2, and a function/user classification-corresponding information d3 that are related to each image processing apparatus X that the administering server 31 can be communicated with through the network 30.

As depicted in (b) of FIG. 7, the user registration information D12 is the information that identifying information of each user (a user ID d5 and a password d6) and a user classification d7 are related to each other.

The user classification d7 is the information that indicates the classification of each user and, for example, one user classification d7 is set for each section. That is, the user registration information D12 is the information that indicates which user classification d7 (for example, a section) each user belongs to.

The function/user classification-corresponding information d3 is the information that each job processing functions the use of which is permitted and the user classification d7 are related to each other. An example of the user-corresponding function restriction information D11 depicted in (a) of FIG. 7 shows that the setting is made such that, in an apparatus A that is an image processing apparatus X, for the image reading function (SC) and the facsimile communication function (FX), the use of them is permitted to all users (ALL) and, for the printing function (PR) and-the file transmitting function (FS), the use of them is permitted to users with the user classification d7 of “A” and is prohibited to other users.

In the processing at step S402, the administering server 31 identifies the function/user classification-corresponding information d3 and the user classification d7 in the user-corresponding function restriction information D11 using as searching keys the communication address d2 of the image processing apparatus X (identifying information) and the user identifying information d5 and d6 included in the information of the user authentication request.

Based on the identified function/user classification-corresponding information d3 and the user classification d7, the administering server 31 judges whether the user who is the authentication request originator is permitted or prohibited to use each job processing function in the image processing apparatus X that is the authentication request origin.

### [Steps S404 and S405]

The administering server 31 checks at any time (for example, periodically) whether a request for predetermined candidate substitutes has been received from the image processing apparatus X through the NIC that the image processing apparatus X itself includes (S404). The request for candidate substitutes includes the communication address d2 (identifying information) of the image processing apparatus X that is the request origin, in addition to a predetermined request command.

When the administering server 31 detects that the administration server 31 has received the request for candidate substitutes, the administering server 31 extracts a list of the apparatus name d1 and the communication address d2 from the user-corresponding function restriction information D11 for remaining image processing apparatuses X excluding the image processing apparatus X that is the request origin, and transmits (responds) the list as candidates of the substitute to the image processing apparatus X that is the request origin (S405).

### [Steps S406 to S408]

The administering server 31 checks at any time (for example, periodically) whether the information of a predetermined permission/rejection of substitute judgment request sent from the image processing apparatus X has been received through the NIC that the image processing apparatus X itself has (S406). The information of a predetermined permission/rejection of a substitute judgment request includes the information that indicates the type of a job processing function for which it is judged whether the execution of the job processing by a substitute is permitted, the communication address d2 of the image processing apparatus X (identifying information) that is the subject of the judgment, and the identifying information of a user (user ID d5 and password d6) who has transmitted or inputted the job to the image processing apparatus X that is the request origin, in addition to a predetermined request command.

When the administering server 31 has detected that the administering server 31 has received the information of the permission/rejection of substitute judgment request, the administering server 31 executes a permission/rejection of substitute judging processing based on each of the information included in the request information (S407).

The permission/rejection of substitute judgment request referred to herein is the processing for judging whether a user who is the judgment request origin is permitted or prohibited, at the time, to use the job processing function to be judged in the image processing apparatus X that is to be judged (that is not the image processing apparatus X that is the judgment request origin).

The administering server 31 transmits (responds) the judgment result at step S407 to the image processing apparatus X that is the request origin (S408).

Description will be given below for the permission/rejection of substitute judging processing at step S407.

In the processing at step S408, similarly to the processing at step S402, the administering server 31 executes the user authenticating processing based on a combination of the communication address d2, the user identifying information d5 and d6 of the image processing apparatus X to be judged included in the information of the permission/rejection of substitute judgment request.

When the administering server 31 judges that the use of the job processing function to be judged is prohibited based on the user authenticating processing, the administering server 31 decides this judgment result as the judgment result of the permission/rejection of substitute judging processing.

When the administering server 31 judges that the use of the job processing functions to be judged is permitted based on the user authenticating processing, similarly to the processing at step S202 (FIG. 4), the administering server 31 judges the use restriction (that is, whether the use is permitted or prohibited) of the job processing function in the image processing apparatus X to be judged based on the weekly schedule WS corresponding to the communication address d2 of the image processing apparatus X to be judged and the time of day at that moment (current time).

In this case, the administering server 31 determines the judgment result based on the weekly schedule WS as the judgment result of the permission/rejection of substitute judging processing.

In this manner, when the administering server 31 judges to permit the use of the job processing functions to be judged in both of the processing of the user authenticating processing and the judging processing based on the weekly schedule WS, the administering server 31 determines that the permission of the use is the final judgment result in the permission/rejection of substitute judging processing and, otherwise, determines that the prohibition of the use is the final judgment result. Needless to say, the order of the processing does not matter.

### [Step S409]

The administering server 31 checks at any time (for example, periodically) whether the information of a predetermined processing request for the execution by a substitute sent from the image processing apparatus X has been received through the NIC that the image processing apparatus X itself has (S409). The information of a predetermined processing for the execution by a substitute includes jobs executed by a substitute (jobs for which the execution by a substitute is requested) that are a part or all of the jobs received or inputted at the request origin, and the communication address d2 of the image processing apparatus X (identifying information) of the substitute, in addition to a predetermined request command.

When the administering server 31 detects that the administering server 31 has received the information of the substituting execution processing request, the administering server 31 transfers the jobs executed by a substitute included in the request information to the image processing apparatus X that is the substitute (S410). When the processing result of the substituted jobs has returned from the image processing apparatus X that is the substitute, the administering server 31 transfers the processing result to the request origin of the processing request for the execution by a substitute (the image processing apparatus X) (S410).

Description will be given for the processing that the image processing apparatus X executes in the job control for the execution by a substitute. An example described below is an example of the case where the jobs provided to the image processing apparatus X are inputted (designated) through the operating and displaying unit 2.

### [Steps S301 and S302]

The main controlling unit 9 in the image processing apparatus X monitors whether any operation input is executed through the operating and displaying unit 2 (S301).

When the main controlling unit 9 detects that any operation input has been executed through the operating and displaying unit 2, the main controlling unit 9 causes the operating and displaying unit 2 to display a predetermined input picture and executes a processing for inputting the user identifying information d5 and d6 according to the operation input of a user (S302).

### [Step S303]

The main controlling unit 9 transmits the information of the user authentication request including the user identifying information d5 and d6 inputted at step S302 and the communication address of the image processing apparatus X (the address stored in the flash memory 56 of the NIC 5) to the administering server 31 through the NIC 5 (S303).

The main controlling unit 9 judges whether the use of each of the job processing function in the image processing apparatus X is permitted or prohibited (function restriction) to a user who corresponds to the user identifying information inputted at step S302 individually for each of the job processing function (an example for the plurality of classifications) based on the response to the user authentication request and the energizing state of each functional block at this time (the ON/OFF state of each of the automatic circuit changing switches 42 to 44) (S303). The response obtained from the administering server 31 at step S303 is the function restriction information that the administering server 31 transmits at the above step S403 (information that indicates permission or prohibition of the use of each of the job processing function). As described above, the main controlling unit 9 prohibits the use of the job processing functions that need the operations of the functional blocks to which energizing is stopped.

Thereafter, the main controlling unit 9 causes a predetermined storing unit to store the judgment result obtained in the processing at step S403 until the user identifying information d5 and d6 are newly inputted and, when the jobs are set, controls such that the use of only the job processing functions the use of which is judged to be permitted is permitted and the use of other job processing functions is prohibited (an example of the function prohibition controlling unit). Therefore, the jobs that need to use the job processing functions the use of which is prohibited are not processed by the image processing apparatus alone.

For example, when the user-corresponding function restriction information D11 as depicted in (a) of FIG. 7 is set, the main controlling unit 9 controls whether the use is permitted or prohibited for the copying job separately for the image reading function and the printing function of the job processing functions that the copying job needs to use.

Based on the information obtained by the communication with the administering server 31 through the NIC 5 (S102, S104, and S303), the main controlling unit 9 controls whether the use of the job processing functions of the image processing apparatus itself is permitted or prohibited. Therefore, the load caused by the processing can be smaller than that caused in the case where all of the judging processing of the function restriction based on the weekly schedule WS and the user authentication are executed in the image processing apparatus itself.

The communication that the main controlling unit 9 executes with the administering server 31 (S102 and S303) is accompanied by the transmission of the identifying information d5 and d6 of the request originator (the user) of the setting job obtained through the NIC 5 or the operating and displaying unit 2 (an example of the information input unit) and the communication address d2 (identifying information) of the image processing apparatus X stored in advance in the flash memory 56 of the NIC 5. Thereby, restriction of the job processing function for each image processing apparatus and each user is realized. Surely, an embodiment can be considered that realizes only either restriction of the job processing functions for each image processing apparatus or the restriction of job processing functions for each user by transmitting only either the user identifying information d5 and d6 or the communication address d2.

### [Steps S304, S305, and S311]

As a result of the judgment at step S303, the main controlling unit 9 judges whether one or more job processing function(s) the use of which is permitted exist or not (S304). When no job processing function the use of which is permitted exist, the main controlling unit 9 causes the operating and displaying unit 2 to output a notice of that effect (S311) and, thereafter, returns the processing to the above step S301.

When the main controlling unit 9 judges that one or more job processing functions the use of which is permitted exist, the main controlling unit 9 executes the setting processing (input processing) of the jobs to be processed from now on (such as the copying job and the file transmitting job) according to the operation inputted by a user through the operating and displaying unit 2 (S305). Hereinafter, the job set at step S305 is referred to as “setting job”.

### [Steps S306 and S312]

The main controlling unit 9 judges the job processing functions that need to be used for processing the setting job and, based on the judgment result at step S303, judges whether all of the job processing functions that need to be used are permitted to be used (that is, whether the setting job can be processed only by the image processing apparatus itself) (S306).

When the main controlling unit 9 judges that the image processing apparatus itself can process the setting job, the main controlling unit 9 causes the image processing apparatus to process the setting job by itself (S312) and, thereafter, returns the processing to step S301.

Hereinafter, the portion of the setting job which is prohibited to be processed by the image processing apparatus X itself (the portion that uses the job processing functions the use of which is prohibited by the main controlling unit 9 and the MPU 53 of the NIC 5) is referred to as “execution-prohibited portion of the setting job”. For the execution-prohibited portion of the setting job, the cases can be considered where the portion is the whole of the setting job and is a part of the setting job.

### [Step S307]

When the main controlling unit 9 judges that the image processing apparatus itself can not process the setting job only by itself, the main controlling unit 9 executes a processing for setting a substitute that executes the execution-prohibited portion of the setting job (hereinafter, “substitute setting processing”) according to a predetermined operation input (input of a selecting operation) through the operating and displaying unit 2 (S307, an example of the substitute determining apparatus setting unit).

The substitute setting processing is a processing for setting a communication address (identifying information) of a substitute (another image processing apparatus X) to be designated as an image processing apparatus to be judged when the permission/rejection of substitute judgment request (a request that the administering server 31 receives at step S406) is issued to the administering server 31.

Basically, the main controlling unit 9 first transmits a request of the candidate substitute to the administering server 31 through the NIC 5 and receives a list of candidate substitutes (a list of the apparatus name d1 and the communication address d2 of each of the candidate substitutes) that is the response to the request (S307).

The main controlling unit 9 causes the operating and displaying unit 2 to display the list of candidate substitutes obtained by the communication with the administering server 31 and selects one or more substitutes from the list according to a predetermined operation input (input of a selecting operation) through the operating and displaying unit 2. The main controlling unit 9 sets the communication address of the selected substitute as the communication address (identifying information) of the substitute (the other image processing apparatus X to be judged as a substitute) designated in the permission/rejection of substitute judgment request. Otherwise, the list stored in advance in the storing unit of the image processing apparatus itself such as the HDD 3 or the flash memory 56 of the NIC 5 may be used as the list of candidate substitutes.

### [Step S308]

The main controlling unit 9 transmits the information of the permission/rejection of substitute judgment request to the administering server 31 through the NIC 5 and, based on the response thereto, executes the judgment of the permission/rejection of substitute (S308).

As described above, the information of the permission/rejection of substitute judgment request includes the information indicating the type of the job processing function to be judged as to whether the execution of the job processing by a substitute is permitted, the communication address d2 of the image processing apparatus X to be judged in the judgment (the communication address set at step S307), and the identifying information of the user who has inputted the job into the image processing apparatus X that is the request origin (the user ID d5 and the password d6 inputted at step S302).

The information about the type of the job processing function to be judged that the permission/rejection of substitute judgment request includes, is the information that indicates the job processing functions the use of which has been judged to be prohibited by the image processing apparatus itself at step S303 (that is, the job processing functions that is used in the execution-prohibited portion of the setting job).

The response to the permission/rejection of substitute judgment request is the judgment result of the permission/rejection of substitute that the administering server 31 transmits at the above step S408 (whether the use of the job processing functions to be judged is permitted in other image processing apparatuses) to be judged).

### [Steps S309 and S313]

The main controlling unit 9 judges for the execution-prohibited portion of the setting job whether the execution of the job processing by a substitute is permitted in another image processing apparatus based on the judgment result of the permission/rejection of substitute obtained by the communication (S308) with the administering server 31 at step S308 (S309, an example of the substitute judgment unit).

In this manner, the main controlling unit 9 judges whether other image processing apparatuses permit the execution of the job processing by a substitute based on the information obtained by the communication (S308) with the administering server 31 (an example of the relaying apparatus) through the NIC 5 (S309).

In this step, when the main controlling unit 9 judges that the execution by a substitute of the execution-prohibited portion of the setting job is not permitted, the main controlling unit 9 causes the operating and displaying unit 2 to output a notice of that effect (a notice of non-permission of the processing) (S313) and, thereafter, returns the processing to step S301.

### [Step S310]

When the main controlling unit 9 judges that the execution by a substitute of the execution-prohibited portion of the setting job is permitted, the main controlling unit 9 executes the processing of the setting job (S310) and, thereafter, returns the processing to the above S301.

However, at this step S310, for the portion of the setting job that the image processing apparatus itself can process (the portion that uses the job processing functions that the image processing apparatus itself permits to use), the main controlling unit 9 causes the image processing apparatus itself to process by controlling the corresponding functional blocks. For the execution-prohibited portion of the setting job that the processing thereof by the image processing apparatus itself is prohibited, the main controlling unit 9 causes the other image processing apparatus X that the main controlling unit 9 has judged to permit the execution by a substitute of the job processing at step S309 to execute the processing by a substitute, by transmitting the information of the request for the processing by a substitute to the administering server 31 (the example of the relaying apparatus) through the NIC 5 (S310, an example of the controlling unit of a job execution by a substitute). As described above, the information of request for the execution of processing by a substitute includes the job to be executed by a substitute (a job that requests the execution of processing by a substitute) that is a portion or the whole of the setting job, and the communication address d2 of the image processing apparatus X that is the substitute (the communication address d2 set at step S307).

Thereby, the jobs to be executed by a substitute are transferred by the administering server 31 to the substitute (the other image processing apparatus X that has been judged to be permitted to execute the job processing as a substitute at step S309) (S410) and the processing is executed by a substitute.

At this step, the order of the processing of the setting job executed in the image processing apparatus itself and in the substitute is determined depending on the contents of the setting job (the order of the use of the job processing functions).

For example, when the setting job is a copying job and, as a result of the judgment at step S303, the use of the image reading function is permitted and the use of the printing function is prohibited (for example, when the user-corresponding function restriction information D11 depicted in (a) of FIG. 7 is designated), the main controlling unit 9 operates as follows at step S310.

In this case, the main controlling unit 9 causes the image processing apparatus itself to process the portion of the copying job that is designated that uses the image reading function (the image reading processing) by controlling the scanner unit 6, and causes other image processing apparatus X to execute as the substitute the printing processing based on the printing data obtained by the above image reading processing.

The example depicted in FIGS. 6A and 6B is an example of the case where the setting job (the job provided to the image processing apparatus X) is a job inputted (designated) through the operating and displaying unit 2. However, the same holds even when the setting job is a job sent from the terminal 32 and received through the NIC 5. In this case, in the example depicted in FIGS. 6A and 6B, the information inputted through the operating and displaying unit 2 (such as the user identifying information and the input information of the selecting operation of the substitute) is obtained by receiving this information from the terminal 32 through the NIC 5.

In the above embodiment, the main controlling unit 9 of the image processing apparatus X (an example of controlling unit of the job execution by a substitute) controls the job processing to be executed by a substitute by transmitting the execution-prohibited portion of the setting job (a portion or the whole of the job) to the administering server 31 (the example of the relaying apparatus) that can communicate with the other image processing apparatus through the NIC 5.

However, another embodiment can be considered in which the main controlling unit 9 of the image processing apparatus X causes another image processing apparatus (a substitute) that is judged to be permitted executing jobs as a substitute by the unit 9 at step S309 to execute the job processing for the image processing apparatus X by directly transmitting the job (the execution-prohibited portion of the setting job) to the substitute.

The above embodiment showed an example according to which the main controlling unit 9 controls whether the use of the job processing functions of the image processing apparatus itself is permitted or prohibited based on the information obtained by the communication (S102, S104, and S303) with the administering server 31 through the NIC 5. However, another embodiment can be considered.

For example, an embodiment can be considered which the MPU 53 of the NIC 5 or the main controlling unit 9 (an example of the function prohibition controlling unit) judges whether the use of the image processing apparatus itself is permitted or prohibited and controls, based on a predetermined prohibiting condition determined in advance.

In this case, the image processing apparatus X is constructed as follows, for example.

The NIC 5 includes a clock circuit that counts the current time. The flash memory 56 of the NIC 5 stores in advance the weekly schedule WS of the image processing apparatus itself.

The MPU 53 of the NIC 5 executes the judging processing (S202 and S204) of the function restriction based on the weekly schedule WS (an example of a schedule condition determined in advance) executed by the administering server 31 in the example depicted in FIG. 4.

The HDD 3 stores in advance the information about the user authentication of the image processing apparatus itself (user-corresponding function restriction information D11 and the user registration information D12).

The main controlling unit 9 executes the user authenticating processing (S402) based on the information on the user authentication (an example of the user authentication condition) executed by the administering server 31 in the example depicted in FIGS. 6A and 6B.

When each image processing apparatus X judges the restriction of the job processing functions of the image processing apparatus X itself, the main controlling unit 9 (an example of a judging unit of a substitute) executes judgment as to whether another image processing apparatus permits the execution of job processing as a substitute (S309) based on the information obtained by executing the requesting processing (S308) of judging permission/rejection of executing as a substitute to other image processing apparatuses X through the NIC 5.

In this case, the main controlling unit 9 of each image processing apparatus X executes, in response to the requests another image processing apparatus, the processing for judging permission/rejection of executing as a substitute (S407) that the administering server 31 executes in response to the request from the image processing apparatus X in the example depicted in FIGS. 6A and 6B.

The above configuration is also an example of an embodiment of the present invention.

The above embodiment describes an example according to which the main controlling unit 9 executes the substitute setting processing for setting the substitute for executing the execution-prohibited portion of the setting job according to the predetermined operation input through the operating and displaying unit 2 (S307). However, another embodiment can be considered.

For example, it can be considered that the main controlling unit 9 issues a predetermined preliminary inquiry to: the external apparatuses that can be communicated through the network 30 by broadcasting communication through the NIC 5 and, based on the response obtained thereby, executes the processing for automatically obtaining the communication address (identifying information) of other image processing apparatuses that are the objects for judging permission/prohibition of executing as subjects.

The present invention can be used for an image processing apparatus.

According to the present invention, in an image processing apparatus, prohibition and permission of the use of a plurality of job processing functions can be controlled individually for each of a plurality of classifications. Therefore, according to the importance in executing the appropriate administration of the depletion load of the apparatus and confidential data (such as administration by section and schedule administration), prohibiting conditions of the job processing functions can be different conditions. Thereby, the administration of the depletion load and confidential data of the apparatus can be optimized while the degradation of the convenience caused by the use restriction control can be minimized.

In addition, even when a part of the jobs to be processed uses the job processing functions the use of which is prohibited, the job is processed by another image processing apparatus that permits the execution of the job processing as a substitute, not by canceling the use restriction (use prohibition) when the job processing is executed by a substitute that is described in Japanese Patent Application Laid-Open Publication Nos. 2003-076521. Thereby, the degradation of the convenience caused by the use prohibition control can be minimized without disturbing the appropriate administration of the depletion load and confidential data.

As set forth hereinabove, according to the present invention, by combining the use restriction (use prohibition) for each job processing function and the execution of a part of jobs by another image processing apparatus as a substitute, the appropriate administration of the depletion load of the apparatus and confidential data (such as administration by section and schedule administration) can be facilitated without victimizing the convenience as much as possible.

1. An image processing apparatus having a communicating unit that executes a communication processing with external apparatuses, and a job processing unit that has a plurality of job processing functions to process a job obtained through the communicating unit or a job designated through a predetermined operation input unit, comprising:
a function prohibition controlling unit that controls individually for each of a plurality of classifications whether use of the job processing functions is permitted or prohibited;
a substitute determining unit that judges whether another image processing apparatus permits as a substitute the execution of a job processing for a part or all of the jobs that use the job processing functions the use of which is prohibited by the function prohibition controlling unit by communicating with external apparatuses through the communicating unit; and
a controlling unit of a job execution by a substitute that causes another image processing apparatus for which the substitute determining unit judges to permit processing the job as a substitute by transmitting a part or all of the jobs that need to use the job processing functions the use of which is prohibited by the function prohibition controlling unit through the communicating unit to the external apparatus.

2. An image processing apparatus as defined in claim 1, wherein:
the function prohibition controlling unit controls whether the use is permitted or prohibited separately for each of the image reading function and the printing function of the job processing functions that, at least, a copying job needs to use; and
the controlling unit of a job execution by a substitute causes another image processing apparatus to execute as a substitute the printing processing based on printing data obtained by using the image reading function of the image processing apparatus that has this controlling unit for the copying job when the function prohibition controlling unit permits the use of the image reading function and prohibits the use of the printing function.

3. An image processing apparatus as defined in claim 1, wherein:
the controlling unit of a job execution by a substitute causes another image processing apparatus to execute as a substitute the job processing by transmitting a part or the whole of the job through the communicating unit to that other image processing apparatus or a predetermined relaying apparatus that can communicate with that other image processing apparatus.

4. An image processing apparatus as defined in claim 1, wherein:
the function prohibition controlling unit controls whether the use of the job processing functions of the image processing apparatus that has this function prohibition controlling unit is permitted or prohibited based on a prohibition condition defined in advance.

5. An image processing apparatus as defined in claim 4, wherein:
the prohibition condition is a condition that includes one or both of the user authenticating condition based on the identifying information of a requester of the job obtained through the communicating unit or a predetermined information input unit, and a condition based on a time schedule defined in advance.

6. An image processing apparatus as defined in claim 1, wherein:
the function prohibition controlling unit controls whether the use of the job processing functions of the image processing apparatus that has this function prohibition controlling unit is permitted or prohibited based on the information obtained by the communication with an external apparatus through the communicating unit.

7. An image processing apparatus as defined in claim 6, wherein:
the communication that the function prohibition controlling unit executes with the external apparatus accompanies transmission of one or both of the identifying information of a requester of the job obtained through the communicating unit or a predetermined information input unit, and the identifying information of the image processing apparatus that a predetermined storing unit stores in advance.

8. An image processing apparatus as defined in claim 1, wherein:
the substitute determining unit judges whether another image processing apparatus permits the execution of the job processing as a substitute based on the information obtained by the communication with an external apparatus through the communicating unit.

9. An image processing apparatus as defined in claim 8, wherein:
a communication counterpart of the substitute determining unit is another image processing apparatus or a predetermined relaying apparatus that can communicate with that other image processing apparatus.

10. An image processing apparatus as defined in claim 8, further comprising:
a substitute automatic obtaining unit that automatically obtains the identifying information of another image processing apparatus to be judged by the substitute determining unit based on a response obtained by issuing a predetermined preliminary inquiry to an external apparatus by broadcasting transmission through the communicating unit.

11. An image processing apparatus as defined in claim 1, further comprising:
a substituting execution determining apparatus setting unit that sets the identifying information of another image processing apparatus to be judged by the substitute determining unit according to the operation input through a predetermined operation input unit.

12. An image processing apparatus as defined in claim 11, wherein:
the substituting execution determining apparatus setting unit sets the identifying information of another image processing apparatus to be judged by the substitute determining unit, by selecting the identifying information according to the operation input through a predetermined operation input unit from candidates of the identifying information stored in advance in a predetermined storing unit or candidates of the identifying information obtained from external apparatuses through the communicating unit.

13. An image processing apparatus as defined in claim 2, wherein:
the controlling unit of a job execution by a substitute causes another image processing apparatus to execute as a substitute the job processing by transmitting a part or the whole of the job through the communicating unit to that other image processing apparatus or a predetermined relaying apparatus that can communicate with that other image processing apparatus.

14. An image processing apparatus as defined in claim 2, wherein:
the function prohibition controlling unit controls whether the use of the job processing functions of the image processing apparatus that has this function prohibition controlling unit is permitted or prohibited based on a prohibition condition defined in advance.

15. An image processing apparatus as defined in claim 2, wherein:
the function prohibition controlling unit controls whether the use of the job processing functions of the image processing apparatus that has this function prohibition controlling unit is permitted or prohibited based on the information obtained by the communication with an external apparatus through the communicating unit.

16. An image processing apparatus as defined in claim 2, wherein:
the substitute determining unit judges whether another image processing apparatus permits the execution of the job processing as a substitute based on the information obtained by the communication with an external apparatus through the communicating unit.

17. An image processing apparatus as defined in claim 2, further comprising:
a substituting execution determining apparatus setting unit that sets the identifying information of another image processing apparatus to be judged by the substitute determining unit according to the operation input through a predetermined operation input unit.
